(19) United States
(12) Patent Application Publication
(10) Pub. No.: US 2023/0321826 A1
(43) Pub. Date: Oct. 12, 2023

(54) Method for Controlling a Robotic Device

(71) Applicant: Robert Bosch GmbH, Stuttgart (DE)

(72) Inventors: Markus Spies, Karlsruhe (DE); Meng Guo, Beijing (CN); Philipp Christian Schillinger, Renningen (DE); Sergey Alatartsev, Boeblingen (DE)

(21) Appl. No.: 18/295,389

(22) Filed: Apr. 4, 2023

(30) Foreign Application Priority Data
Apr. 6, 2022 (DE) 10 2022 203 410.4

(51) Int. Cl. B25J 9/16

(52) U.S. Cl. CPC B25J 9/1653; B25J 9/1661; B25J 9/1687; B25J 9/161

(57) ABSTRACT

A method for controlling a robotic device includes, for each control vector from a plurality of control vectors: controlling the robotic device to perform a sequence of actions, the control vector indicating which action is to be performed for a respectively observed control situation; and determining, by the sequence of actions, values of multiple target metrics that evaluate the performance of a specified task. The method then adjusts a probability distribution of the control vectors such that the probability of control vectors is increased for which the specified task was performed with high evaluations and the multiple target metrics have satisfied at least one target condition; randomly selects a control vector according to the probability distribution for performing the task in a current control scenario; and controls the robotic device to perform a sequence of actions, the control vector indicating which action is performed for a respectively observed control situation.

This application claims priority under 35 U.S.C. § 119 to patent application no. 10 2022 203 410.4, filed on Jun. 4, 2022 in Germany, the disclosure of which is incorporated herein by reference in its entirety.

The present disclosure relates to methods used for controlling a robotic device.

### BACKGROUND

A robotic device, such as a robotic arm, that is intended to remove objects from a container should be able to adapt to various situations, e.g. starting conditions. For example, if an object is on the edge rather than in the center of a container, the robot should also be able to pick up the object. However, the robot can need to perform an additional action to this end, e.g. push the object to the center.

Approaches are therefore required to control a robotic device that enables successful and efficient control for various situations.

### SUMMARY

According to various embodiments, a method for controlling a robotic device is provided, comprising the following for each control vector from a plurality of control vectors: controlling the robotic device to perform a sequence of actions, wherein the control vector indicates which action is to be performed for a respectively observed control situation; and determining, by the sequence of actions, the values of multiple target metrics that evaluate the performance of a specified task. The method further comprises adjusting a probability distribution of the control vectors such that the probability of control vectors is increased for which the specified task was performed with high evaluations and the multiple target metrics have satisfied at least one target condition; randomly selecting a control vector according to the probability distribution for performing the task in a current control scenario; and controlling the robotic device to perform a sequence of actions, wherein the control vector indicates which action is to be performed for a respectively observed control situation.

The method described above allows a control of the robotic device that conforms to the circumstances in which it is deployed. Each control vector can be considered a representation of a control strategy, and control vectors (or similar control vectors) that result in successful control (in the sense of satisfying the at least one target condition and good results with respect to the target metrics) are increasingly preferred over time so that the control unit increasingly adjusts.

Various embodiment examples are specified hereinafter.

Embodiment example 1 is a method used for controlling a robotic device, as described above.

Embodiment example 2 is the method according to embodiment example 1, wherein the control vector indicates parameters of the actions for a control situation observed in each case for at least some of the actions.

Thus, the machine-learning model (represented by the probability distribution that is adjusted) not only learns good sequences of actions (or decisions that lead to a good sequence of actions in terms of the target metrics depending on the control scenario and the control situation) but also how the actions (in a control situation that has currently been observed) are to be parameterized. This in particular increases the degrees of freedom in the optimization of the control and thus allows for a better optimization result.

Embodiment example 3 is the method according to embodiment example 1 or 2, wherein the task comprises picking up an object from a container.

In particular, in such an application, the selection of actions taken is critical to how well the task is performed, for example because a decision must be made as to whether an object can be gripped right away or must first be moved. By adjusting the probability distribution based on successful control runs, the respective control unit that performs the method learns to adapt to different scenarios such as object types, grippers, and lighting situations and make appropriate decisions for them.

Embodiment example 4 is the method according to any one of embodiment examples 1 to 3, wherein the adjustment of the probability distribution is carried out by means of a gradient-free optimization process.

An example of this is CMA-ES (Covariance Matrix Adaptation Evolution Strategy). This allows for optimization with respect to multiple target metrics and taking into account the target conditions of the parameters of the machine-learning model (specifically the probability distribution), because no single real evaluation needs to be present (i.e. not a real value of a loss function, for example), but can also be optimized with respect to a vector-like target (values of multiple target metrics).

Embodiment example 5 is a robotic device control unit configured so as to carry out a method according to any one of embodiment examples 1 to 4.

Embodiment example 6 is computer program comprising commands that, when executed by a processor, cause said processor to perform a method according to any one of the embodiment examples 1 to 4.

Embodiment example 7 is a computer-readable medium which stores commands that, when executed by a processor, cause said processor to perform a method according to any one of the embodiment examples 1 to 4.

### BRIEF DESCRIPTION OF THE DRAWINGS

In the drawings, like reference numbers generally refer to the same parts throughout the different views. The drawings are not necessarily to scale, wherein emphasis is instead generally placed on representing the principles of the disclosure. In the following description, various aspects are described with reference to the following drawings.

FIG. 1 shows a robot.

FIG. 2 illustrates the control of a technical system by a control unit.

FIG. 3 illustrates various sequences of primitives in the case of picking up an object from a container so that a barcode of the object can be inspected.

FIG. 4 shows a flowchart depicting a method used for controlling a robotic device according to an embodiment.

### DETAILED DESCRIPTION

The following detailed description relates to the accompanying drawings, which, for clarification, show specific details and aspects of this disclosure in which the disclosure can be implemented. Other aspects can be used, and structural, logical, and electrical changes can be made without departing from the scope of protection of the disclosure. The various aspects of this disclosure are not necessarily mutually exclusive, because some aspects of this disclosure can be combined with one or more other aspects of this disclosure to form new aspects.

Different examples will be described in further detail in the following.

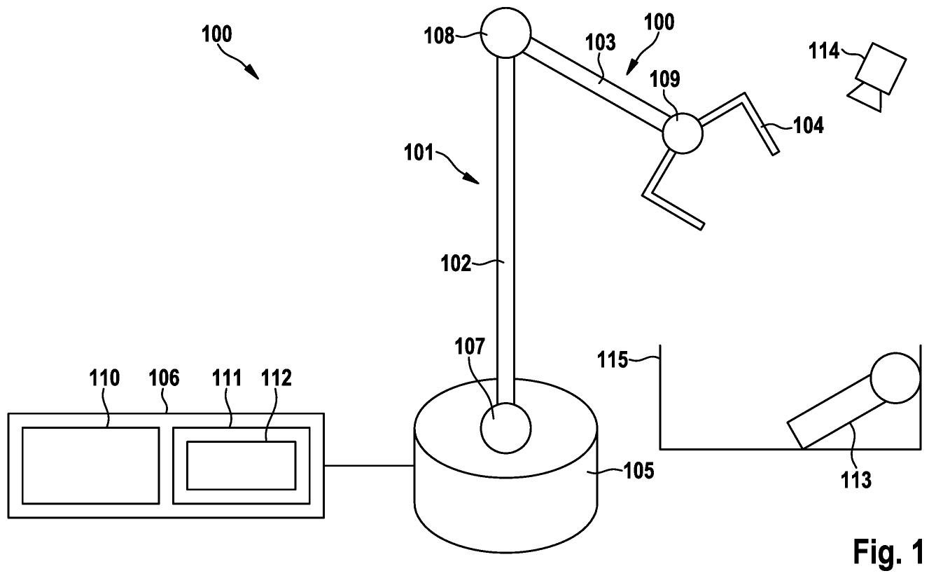

FIG. 1 shows a robot 100.

The robot 100 comprises a robot arm 101, for example an industrial robot arm for handling or assembling a workpiece (or one or more other objects). The robotic arm 101 comprises manipulators 102, 103, 104 and a base (or support) 105, by means of which the manipulators 102, 103, 104 are supported. The term “manipulator” refers to the movable elements of the robotic arm 101, the actuation of which enables physical interaction with the environment, e.g., in order to perform a task. Regarding the control unit, the robot 100 comprises a (robot) control unit 106 configured so as to implement the interaction with the environment according to a control program. The last element 104 (farthest from the support 105) of the manipulators 102, 103, 104 is also referred to as the end effector 104 and can comprise one or more tools, e.g. a welding torch, a gripper, a paint tool, or the like.

The other manipulators 102, 103 (which are closer to the support 105) can form a positioning device so that, together with the end effector 104, the robotic arm 101 is provided with the end effector 104 at its end. The robotic arm 101 is a mechanical arm that can provide functions similar to those of a human arm (possibly with a tool at its end).

The robotic arm 101 can comprise articulation elements 107, 108, 109 connecting the manipulators 102, 103, 104 to one another and to the support 105. An articulation element 107, 108, 109 can comprise one or more articulation joints that can each provide rotary movement (i.e. rotational movement) and/or translational movement (i.e. displacement) for associated manipulators relative to one another. The movement of the manipulators 102, 103, 104 can be initiated by means of actuators controlled by the control unit 106.

The term “actuator” can be understood to mean a component that is designed to influence a mechanism or process in response to being driven. The actuator can convert instructions output by the control unit 106 (referred to as “activation”) into mechanical movements. The actuator, e.g. an electromechanical converter, can be designed to convert, upon its activation, electrical energy into mechanical energy.

The term “control unit” can be understood to mean any type of logic implemented by an entity including, e.g. a circuit and/or a processor capable of executing software, firmware, or a combination of both that is stored in a storage medium, and which can issue commands, e.g. to an actuator in the present example. For example, the control unit can be configured by means of a program code (e.g. software) in order to control the operation of a robotic device.

In the present example, the control unit 106 comprises one or more processors 110 and a memory 111 that stores code and data, based on which the processor 110 controls the robotic arm 101. According to various embodiments, the control unit 106 controls the robotic arm 101 on the basis of a machine-learning model 112 stored in the memory 111. For example, the robot 100 is intended to manipulate an object 113.

At any given time, the overall system composed of robotic arm 101 and object 113 (or other objects) to be manipulated has a particular state with respect to position, orientation, end effector state (gripper open/closed), etc. This state of the system, robot, or object is hereinafter referred to as the control configuration.

A manipulation task performed by, for example, a robotic arm 101 can typically be broken down into a sequence of skills. Such skills are also referred to as primitives or generally as actions. Primitives can be considered elementary skills of the particular robotic device.

It is assumed that for each primitive, the robot 100 has a control function that allows the control unit 106 to control the robotic arm to perform the primitive.

For example, for a primitive that corresponds to a skill in movement, a statistical model (e.g. a Hidden Semi Markov Model) can be trained by learning from demonstrations (LfD). Also for a primitive, such as determining a gripping pose for picking up an object, a model can be learned using machine-learning. For simpler primitives, such as capturing an image of the object by a camera 114, such a control function can also be programmed directly without training a model.

Each primitive is a configurable function that has an effect on the controlled system (in the example of FIG. 1, robot 100 and object 103). A primitive can have one or more preconditions that must be met in order for the function to be performed.

In the following, it is assumed that the manipulation task is to pick up an object 113, e.g. from a container 115 (so-called “bin picking”).

Examples of primitives associated with such a manipulation task are
Capturing the scene:
   Precondition: Camera is active
   Parameters: Camera mode (RGB or RGB-D, screen settings, . . . )
Image processing:
   Precondition: A scene capture is in place
   Parameters: Modifications applied to the image and their internal parameters, e.g. filter size of erosion/dilation operations, changes in image histogram
Simple gripping point calculation (fast, but does not work on complex shapes):
   A scene capture is in place
   Failure threshold, minimum size, . . .
Advanced gripping point calculation (calculates slower, but works with complex shapes)
   Precondition: A scene capture is in place
   Parameters: Maximum calculation time, modeled surface properties, error thresholds, . . .
Make object grippable: Pushing an object out of a corner
   Precondition: Object is too far in one corner.
   Parameters: Corner of the container, manner of approaching the object.
Reorient object (to allow barcode of the object to be visible after gripping):
   Precondition: The barcode is located on the top side of the object.
   Parameters: Manner in which the object is to be reoriented so that the barcode is not on the top side.

A sequence of primitives for sorting multiple objects is, for example:
1. Capturing an image of the scene (e.g. the work area of the robot 100 with object 113)
2. Calculating a list of possible gripping points with evaluations
3. Selecting the gripping point with an evaluation greater than a threshold closest to the camera
4. Checking the feasibility of gripping at the selected gripping point with the motion planner
5. Not feasible, continue at 3.
6. Feasible, continue at 7.
7. Gripping the object
8. Reading the barcode of the object
9. Sorting the object
10. Continue at 1 (if not all objects are sorted yet)

In one set of primitives, even for the same type of task (e.g. transporting objects from one container to another), there can be multiple sequences of primitives required for different scenes. For example, if the object is too close to the corner, it must be pushed out of the corner. Such sequences can be defined manually with fine-tuned rules as to which sequence to select in which scenario.

For example, the above sequence can be fixedly programmed in the control unit 106. However, for more complicated manipulation tasks, the resulting control is often not optimal. According to various embodiments, there is therefore provided a control method (and corresponding control unit) that optimizes the sequence of primitives and their parameters (in particular during the run time). The controlled technical system (robot 100 in the bin-picking example) is thereby enabled to adapt to different application cases, e.g. different object types, gripper types, etc., as well as different ambient conditions such as lighting (which affects primitives such as the gripping point detection).

Such an online optimization (optimization at run time, i.e. during operation) can be realized through black box optimization approaches. This includes Bayesian Optimization (BO) and CMA-ES (Covariance Matrix Adaptation Evolution Strategy). According to various embodiments, CMA-ES is used, because it works better on a large number of samples (i.e. such as results from previous control passes), which is an important aspect in continuously optimizing parameters during operation.

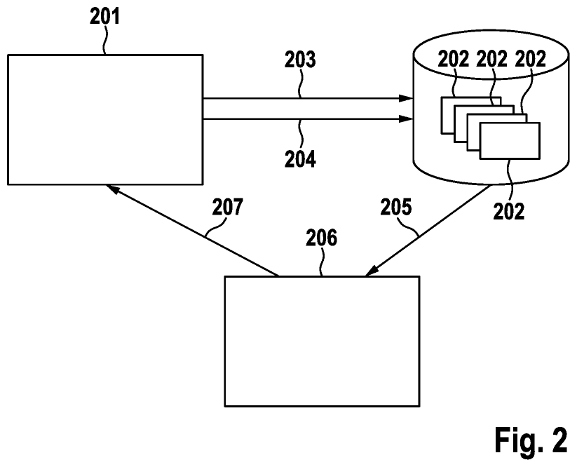

FIG. 2 illustrates control of a technical system 206 by a control unit 201.

The control unit 201 (e.g. control unit 106) accesses a quantity of primitives 202 for which there are control functions (e.g. in control unit 106) according to an ML model 201 (e.g. ML model 112) trained for a target manipulation task. It selects a primitive 202 for each phase of the control unit in 203 and sets parameters in 204 for the selected primitive. The control unit 106 selects a primitive 202 only if all of its preconditions are met (if it has any). It can check this before selecting a primitive. In 205, the control unit 106 applies the selected and configured primitive to the respective controlled system 206 (e.g. the robotic arm 101 and, if applicable, other controlled elements, such as the camera 114) according to the parameters set. In 207, the controlled system 206 supplies sensor data to the control unit (in particular to the ML model 112), e.g. image data or also measurement data of a force sensor.

Each primitive 202 has an effect on the controlled system 206, e.g. it provides an image, the robotic arm 101 moves, the object 113 is gripped, etc. This effect can be sensed by sensors of the system (camera, robot sensor measurements, detection of a successful grasp, etc.) and is provided as feedback via the sensor data in 207 to the ML model 201. By collecting this feedback (i.e. the results that a primitive has with certain parameter values) and training based on this feedback, the ML model 201 can learn the effect of primitives (with associated parameters) and, when trained in this manner for a sufficiently long time, select the primitive and its parameter target for the highest benefit in any control situation (which it recognizes from the sensor data being fed back).

For example, the ML model 201 can learn
to avoid capturing a picture of a scene when it is not necessary: Each scan of the scene (e.g. by capturing one or more images) costs time. If gripping is performed only in one corner of a container, other objects may not be affected, and it is not necessary to scan the scene again. The ML model 201 can learn under what circumstances rescanning is required and in other cases to avoid rescanning. For example, a target metric that causes the ML model 201 to take only one image during training, if possible, is the number of captured images that are to be as small as possible.
to select a gripping method: The control unit can have multiple possibilities (in particular primitives 202) for calculating a gripping point (i.e. a location where an object is gripped). The ML model 201 can learn which of these gripping methods are best applied in the current application case and the current scene (target metric for training: successful gripping, e.g. with as little force as possible), and select one (and configure it, if necessary).
to make objects grippable: In applications for picking up objects from a container, there are instances in which an object is not grippable, for example, because the gripper cannot reach the object in a corner. Corresponding actions to make the object grippable, such as pushing the object out of the corner or shaking the container, can be implemented in the form of primitives 202. It is difficult to firmly program when a particular action to make the object grippable has been successful. The ML model 201 can learn this based on feedback, i.e. results from previous controls (in particular designs of such primitives) (target metric for training: gripping successful, e.g. with as little collisions as possible with the container).

According to various embodiments, a control unit does not use a firmly programmed sequence of primitives, but instead trains a model that decides which primitive to execute next (and how to configure it, i.e. how to set its parameters). The model obtains the current state of the controlled system (including environment such as manipulated objects) as input (e.g. as one or more images, robotic state data, meta-information regarding the task) and outputs the next primitive to be performed and its parameters. In this way, the model can adjust the sequence of primitives to the state of the controlled system and perform the task more efficiently.

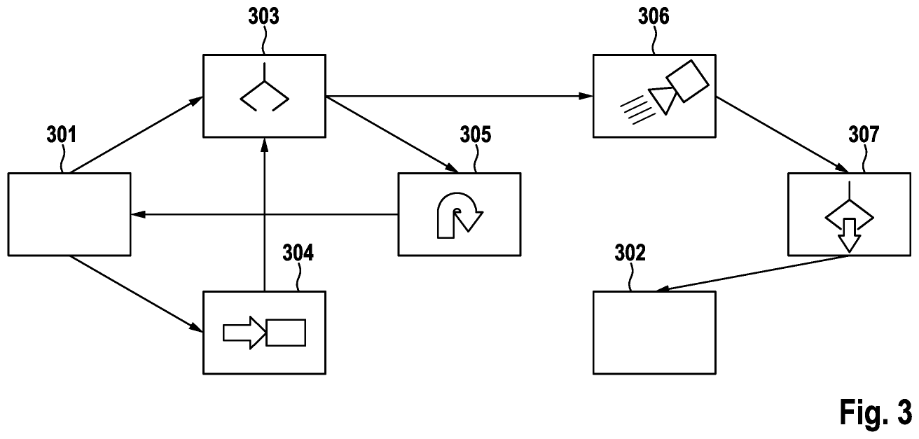

FIG. 3 illustrates various sequences of primitives in the case of picking up an object 113 from a container 115 so that a barcode of the object 113 can be inspected.

Between a starting state 301 and an end state 302, as primitives, a picking up 303, a movement 304, a reorientation (include at the current location) 305, a scanning (of the barcode) 306, and a dropping at the destination 307 can be performed.
In the nominal case, the object 113 is close to the center of the container 115, and its barcode is not at its upper surface. In this case, the sequence of the primitives and their parameters is given by:
Pick up object (parameter: object pose)->Scan barcode (parameter: scanner location)->Drop object (parameter: object destination)
Special case 1: The object 113 is close to an edge of the container 115, and the barcode is not on the upper surface. The sequence and choice of parameters is as in the nominal case, but the control unit 105 uses different trajectories of the robotic arm 101 (in particular the gripper orientation). The selection of the corresponding parameters is automatically made based on the control function (e.g. the learned motion model, e.g. HSMMs) for the corresponding motion capability.
Special case 2: The object 113 is close to a corner of the container 115, and the barcode is not on the upper surface. The sequence and selection of parameters is as follows:
Move the object from the corner to the center of the container (parameter: object pose, center of the container)->Pick up object (parameter: object pose)->Scan barcode (parameter: scanner location)->Store object (parameter: object destination)
Special case 3: The object 113 is near the center of the container 115, but its barcode is not at the upper surface. Then, a reorientation is required compared to the nominal case:
Pick up object (parameter: object pose)->Reorient object (parameter: object pose)->Pick up object (parameter: object pose)->Scan barcode (parameter: scanner location)->Store object (parameter: object destination)
Special case 4: The object 113 is close to an edge or corner of the container 115, and the barcode is not on the upper surface. Then, a reorientation is required in comparison to special case 2:
Move the object from the corner or from the edge to the center of the container (parameter: object pose, center of the container)->Pick up object (parameter: object pose)->Reorient object (parameter: object pose)->Pick up object->Scan barcode (parameter: scanner location)->Drop object (parameter: object destination)

As described above, the ML model 201 receives feedback on configured primitives (i.e. primitives with associated parameter values) that specifically enables it to assess how well a primitive or sequence of primitives is or has been capable of achieving the particular objective. According to various embodiments, a configured primitive or sequence of primitives is evaluated by means of multiple target metrics.

For example, a sequence of configured primitives is performed, and the force exerted by the robot on the object 113 is measured, each as part of the feedback. A target metric is, for example, the measured force (which should be as low as possible) and a condition with respect to this target metric can be that the force does not exceed a specified limit. A further target metric can be the deviation of the achieved destination. This can also provide a rating (as close to the target as possible) and a condition can also be specified for this purpose, e.g. the object can only have a certain highest distance from the destination.

Accordingly, for a control sequence, i.e. a sequence of (configured) primitives from starting state to end state, the control unit can determine values of target metrics, wherein each target metric has an associated optimization target (as low a force as possible, as close to the target) and can have a condition (force must remain below the barrier). Such a condition can or cannot be satisfied for a control flow.

Each sequence of primitives that is performed results from which primitives select the ML model 201 for a particular situation (i.e. a state of the controlled system). The ML model 201 makes these decisions according to a vector of values for a set of control parameters. This vector is also referred to as a control vector. The control vector specifies decision parameter values for decision conditions, for example, that the object is moved when it is closer than x mm to the edge of the container 115, i.e. the ML model 201 makes a particular decision based on the values of bits of the vector determined for that decision.

Thus, the control vector for an instance of the task, i.e. for the task in a particular control scenario (i.e. starting configuration and target configuration), defines a particular control flow (i.e. a sequence of primitives with configuration parameters of the primitives), because it defines the decisions as to which primitives (in response to feedback) are selected and their configuration.

The ML model samples the control vector from a space of control vectors. According to various embodiments, machine-learning model 201 learns from control sequences (where it receives evaluations or determines then from feedback) a probability distribution of the control vectors according to which it further takes samples from the space of control vectors. This is carried out, for example, in accordance with CMA-ES.

The probability distribution is adjusted over time (via multiple control sequences) such that control vectors that resulted in control sequences were met for the target conditions and for which the target metrics have assumed good (i.e. high or low depending on the target metric) values are more likely to be sampled.

The adjustment of the probability distribution is iterative, wherein a quantity of control vectors is evaluated for each iteration and then sorted. The sorting can account for the target metrics (e.g. by a weighted combination (e.g. sum) of the target metrics so that a value can be determined for each target vector and control vectors can be sorted based on these values) as well as control vectors that do not satisfy the target conditions (e.g. for at least one target metric outside of an allowable range), underweight, or out of the sorting. According to the sorting, a portion of the control vectors is then selected (e.g. the n best) and the probability distribution is adjusted in favor of these vectors. In the case of a normally distributed sampling, it includes the expected value of the distribution being shifted towards the mean of the vectors and the covariance matrix being adjusted according to the scattering. In addition, previous parameters of the probability distribution can be considered in order to ensure a more stable adjustment of the distribution.

In other words, the optimization of the target metrics is accomplished by learning the probability distribution, which becomes more and more likely in the course of operation control vectors that lead to good results (in terms of the target metrics).

This adjustment of the probability distribution can be performed in operation via control runs. From a certain number of control runs (or a further criterion, e.g. reliable control over a certain number of control runs), the training can be ended, i.e. the probability distribution can be left the same or even be adjusted more rarely.

Thus, over time, the ML model increasingly selects control vectors that will result in sequences of primitives for which the machine-learning model (according to its past experiences) expects to fulfill the conditions of the target metrics and to well fulfill the target metrics optimization targets.

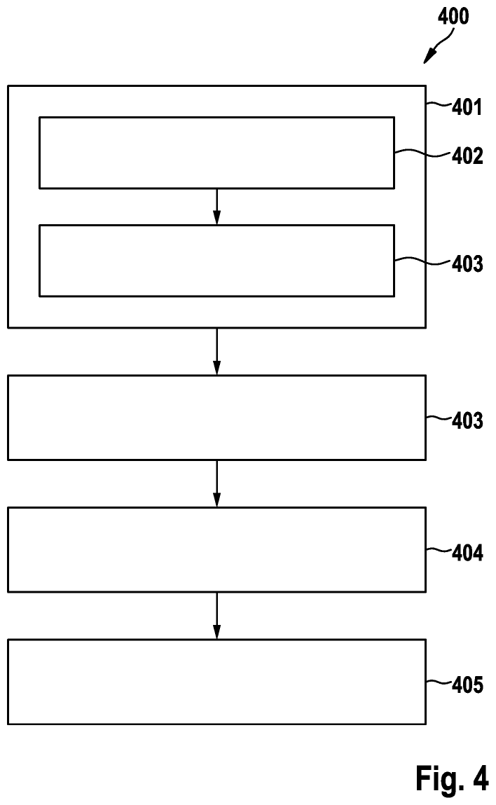

In summary, a method is provided according to various embodiments, as shown in FIG. 4.

FIG. 4 shows a flowchart 400 depicting a method used for controlling a robotic device according to an embodiment.

In 401, for each control vector from a plurality of control vectors,
in 402, the robotic device is controlled so as to perform a sequence of actions, wherein the control vector indicates which action is to be performed for a respectively observed control situation.
in 403, by the sequence of actions, the values of multiple target metrics that evaluate the performance of a specified task are determined.

In 403, a probability distribution of the control vectors is adjusted such that the probability of control vectors is increased for which the specified task was performed with high evaluations and the multiple target metrics have satisfied at least one target condition.

In 404, a control vector is randomly selected according to the probability distribution for performing the task in a current control scenario.

In 405, the robotic device is controlled to perform a sequence of actions, wherein the control vector indicates which action is to be performed for a respectively observed control situation.

The method of FIG. 4 can be carried out by one or more computers comprising one or more data processing units. The term “data processing unit” can be understood to mean any type of means that enables the processing of data or signals. For example, the data or signals can be processed according to at least one (i.e. one or more than one) specific function performed by the data processing unit. A data processing unit can comprise or be configured of an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described here in more detail can also be understood as a data processing unit or logic circuitry. One or more of the method steps described in detail here can be carried out (e.g. implemented) by a data processing unit by means of one or more specific functions executed by the data processing unit.

The approach shown in FIG. 4 can be used to generate a control signal for a robotic device. The term “robotic device” can be understood to mean any technical system (having a mechanical part whose movement is controlled), e.g. a computer-controlled machine, a vehicle, a household appliance, an electric tool, a manufacturing machine, a personal assistant, or an access control system. A control rule for the physical system is learned, and the physical system is then controlled accordingly.

Various embodiments can receive and use sensor signals from various sensors, such as video, radar, LiDAR, ultrasonics, movement, thermal imaging, etc., for example, in order to obtain sensor data regarding demonstrations or states of the system (robot and object or objects) and configurations and scenarios. The sensor data can be processed. This can include the classification of the sensor data or performing semantic segmentation on the sensor data, for example, in order to detect the presence of objects (in the environment in which the sensor data was obtained). Embodiments can be used in order to train a machine-learning system and to control a robot, e.g. autonomously by robot manipulators, in order to accomplish various manipulation tasks under various scenarios. The embodiments are especially applicable to the control and monitoring of the performance of manipulation tasks, e.g. in assembly lines.

For example, the robotic device is a robotic arm that can be used in order to pick up and, if necessary, inspect an object. In this case, the sensor data based on which the robotic arm is controlled comprises, for example, digital color images (RGB images) and depth images (if necessary, in combination, i.e. RGB+D images).

Although specific embodiments have been illustrated and described here, those skilled in the art in the field will recognize that the specific embodiments shown and described may be exchanged for a variety of alternative and/or equivalent implementations without departing from the scope of protection of the present disclosure. This application is intended to cover any adaptations or variations of the specific embodiments discussed here. Therefore, it is intended that the present disclosure be limited only by the disclosure and equivalents thereof.

What is claimed is:

1. A method used for controlling a robotic device, said method comprising:
controlling, for each control vector from a plurality of control vectors, the robotic device to perform a first sequence of first actions, wherein each of the plurality of control vectors indicates which of the first actions is to be performed for a respectively observed control situation;
determining, by the first sequence of first actions, values of multiple target metrics that evaluate performance of a specified task;
adjusting a probability distribution of the plurality of control vectors such that the probability of control vectors is increased for which the specified task was performed with high evaluations and the multiple target metrics have satisfied at least one target condition;
randomly selecting one of the plurality of control vectors according to the probability distribution for performing the task in a current control scenario; and
controlling the robotic device to perform a second sequence of second actions, wherein the one of the plurality of control vectors indicates which of the second actions is to be performed for a respectively observed control situation.

2. The method according to claim 1, wherein the one of the plurality of control vectors indicates parameters of the actions for a control situation observed in each case for at least some of the first actions.

3. The method according to claim 1, wherein the task comprises picking up an object from a container.

4. The method according to claim 1, wherein the adjustment of the probability distribution is carried out using a gradient-free optimization process.

5. A robotic device control unit configured to perform the method according to a claim 1.

6. A computer program comprising commands that, when executed by a processor, cause said processor to perform the method according to claim 1.

7. The computer program of claim 6, wherein the commands are stored on a computer-readable medium.
